(19) United States
(12) Patent Application Publication
(10) Pub. No.: US 2013/0079913 A1
(43) Pub. Date: Mar. 28, 2013

(54) METHODS AND SYSTEMS FOR SEMICONDUCTOR FABRICATION WITH LOCAL PROCESSING MANAGEMENT

(71) Applicants: Chinmay S. Oza, Ballston Spa, NY (US); William J. Fosnight, Saratoga Springs, NY (US); Jan Rothe, Dresden (DE); John R. Robinson, Saratoga Springs, NY (US); Gabriel Gaxiola, Albany, NY (US)

(72) Inventors: Chinmay S. Oza, Ballston Spa, NY (US); William J. Fosnight, Saratoga Springs, NY (US); Jan Rothe, Dresden (DE); John R. Robinson, Saratoga Springs, NY (US); Gabriel Gaxiola, Albany, NY (US)

(73) Assignee: GLOBALFOUNDRIES INC., Grand Cayman (KY)

(21) Appl. No.: 13/247,792

(22) Filed: Sep. 28, 2011

(51) Int. Cl. G06F 19/00

(52) U.S. Cl. 700/100

(57) ABSTRACT

A method and system of semiconductor fabrication are provided. In the method, an equipment unit performs a process on substrates to form processed substrates. The equipment unit also communicates processing data to a local scheduler. The local scheduler schedules removal of processed substrates from the equipment unit and delivery of unprocessed substrates to the equipment unit based on the processing data.

### TECHNICAL FIELD

This document generally relates to methods and systems for semiconductor fabrication, and more particularly relates to such methods and systems that provide local processing management of substrates.

### BACKGROUND

In the global market, manufacturers of mass products must offer high quality devices at a low price. It is thus important to improve yield and process efficiency to minimize production costs. This holds especially true in the field of semiconductor fabrication, where it is essential to combine cutting-edge technology with volume production techniques. It is the goal of semiconductor manufacturers to reduce the consumption of raw materials and consumables while at the same time improving process tool utilization. The latter aspect is especially important since, in modern semiconductor facilities, equipment is required which is extremely cost intensive and represents the dominant part of the total production costs.

Integrated circuits are typically manufactured in automated or semi-automated facilities, by passing substrates including the devices through a large number of process steps to complete the devices. The number and the type of process steps a semiconductor device has to go through may depend on the specifics of the semiconductor device to be fabricated. For instance, a sophisticated CPU may require several hundred process steps, each of which has to be carried out within specified process margins to fulfill the specifications for the device under consideration.

In a semiconductor facility, a plurality of different product types are usually manufactured at the same time, such as memory chips of different design and storage capacity, CPUs of different design and operating speed, and the like. The number of different product types may even reach a hundred or more in production lines for manufacturing ASICs (Application Specific ICs). Each of the different product types may require a specific process flow, and require different mask sets for lithography and specific settings in various process tools, such as deposition tools, etch tools, implantation tools, chemical mechanical polishing (CMP) tools and the like. Consequently, a plurality of different tool parameter settings and product types may be encountered simultaneously in a manufacturing environment. Thus, a mixture of product types, such as test and development products, pilot products, and different versions of products, at different manufacturing stages may be present in the manufacturing environment at a time. Further, the composition of the mixture may vary over time depending on economic constraints and the like, since the dispatching of non-processed substrates into the manufacturing environment may depend on various factors, such as the ordering of specific products, a variable degree of research and development efforts and the like. Thus, frequently, the various product types may have to be processed with a different priority to meet requirements imposed by specific economic or other constraints.

Nevertheless, it remains an important aspect with respect to productivity to coordinate the process flow within the manufacturing environment in such a way that high efficiency of tool utilization is achieved. This is a critical cost factor due to the investment costs and the moderately low “life span” of semiconductor process tools, and is a significant component in the determination of the price of fabricated semiconductor devices.

Accordingly, it is desirable to provide semiconductor fabrication methods and systems that reduce process tool idle time and increase tool utilization by reducing time intervals between the completion of a processing step on a lot of substrates and the commencement of a processing step on a successive lot of substrates. It is also desirable to provide semiconductor fabrication methods and systems that utilize local processing management of substrates to reduce process tool idle time. Furthermore, other desirable features and characteristics of the semiconductor fabrication methods and systems will become apparent from the subsequent detailed description and the appended claims, taken in conjunction with the accompanying drawings and this background.

### BRIEF SUMMARY

Methods and systems for semiconductor fabrication are provided. In accordance with one exemplary embodiment, an equipment unit performs a process on substrates to form processed substrates. The equipment unit also communicates processing data to a local scheduler. The method further provides for the scheduling of the removal of processed substrates from the equipment unit and delivery of unprocessed substrates to the equipment unit by the local scheduler based on the processing data.

In another embodiment, a method of semiconductor fabrication employs local processing management. In the method, a plurality of equipment units is provided. Each equipment unit is associated with a respective local scheduler. A process is performed on substrates with each equipment unit to form processed substrates. Further, each equipment unit communicates processing data to its associated local scheduler. The associated local scheduler schedules removal of processed substrates from each equipment unit to an associated local storage device and delivery of unprocessed substrates from the respective local storage device to each equipment unit based on the respective processing data.

In accordance with another exemplary embodiment, a semiconductor fabrication system is provided. The system includes an equipment unit configured to perform a process on substrates to form processed substrates and configured to produce processing data. The system also includes a local storage device configured to hold substrates and to transport substrates to and from the equipment unit. In the semiconductor fabrication system, a local scheduler is in communication with the equipment unit and the local storage device and is configured to schedule removal of processed substrates from the equipment unit and delivery of unprocessed substrates to the equipment unit based on the processing data.

### BRIEF DESCRIPTION OF THE DRAWINGS

Exemplary embodiments will hereinafter be described in conjunction with the following drawing figures, wherein like numerals denote like elements, and wherein:

FIG. 1 is a schematic view of a conventional prior art system for semiconductor fabrication;

FIG. 2 is a flow chart representing the method performed by the conventional prior art system of FIG. 1;

FIG. 3 is a schematic view of a semiconductor fabrication system in accordance with an exemplary embodiment;

FIG. 4 is a flow chart representing the method performed by the semiconductor fabrication system of FIG. 3;

FIG. 5 is a schematic view of an alternate semiconductor fabrication system in accordance with an exemplary embodiment;

FIG. 6 is a schematic view of an alternate semiconductor fabrication system in accordance with an exemplary embodiment; and

FIG. 7 is a schematic view of an alternate semiconductor fabrication system in accordance with an exemplary embodiment.

### DETAILED DESCRIPTION

The following detailed description is merely exemplary in nature and is not intended to limit the semiconductor fabrication methods and systems contemplated herein. Furthermore, there is no intention to be bound by any theory presented in the preceding background or the following detailed description.

As detailed below, the semiconductor fabrication methods and systems utilize local processing management of substrates, or works-in-progress (WIP). Specifically, local substrate or WIP management units are used for single tools, or for groups of tools to provide improved scheduling, i.e., reduced idle times for tools. Further, the local management units may be used for single local storage devices, or for groups of local storages devices. The local management units are scalable across different types of tools and logic systems. As a result, the local management units may be utilized universally throughout a semiconductor fabrication facility (a “fab”) to provide the facility with a universal distributed management system. The local management units provide the ability to maintain multiple distributed process schedulers across tools having different manufacturers and associated software and logic. As a result, the inefficiencies of a centralized scheduler as well as those of unique dedicated tool schedulers are avoided. As a result of the “real time” schedule decision-making afforded the present method and system, exception management and inefficiency is minimized as the time window for exception events is minimized.

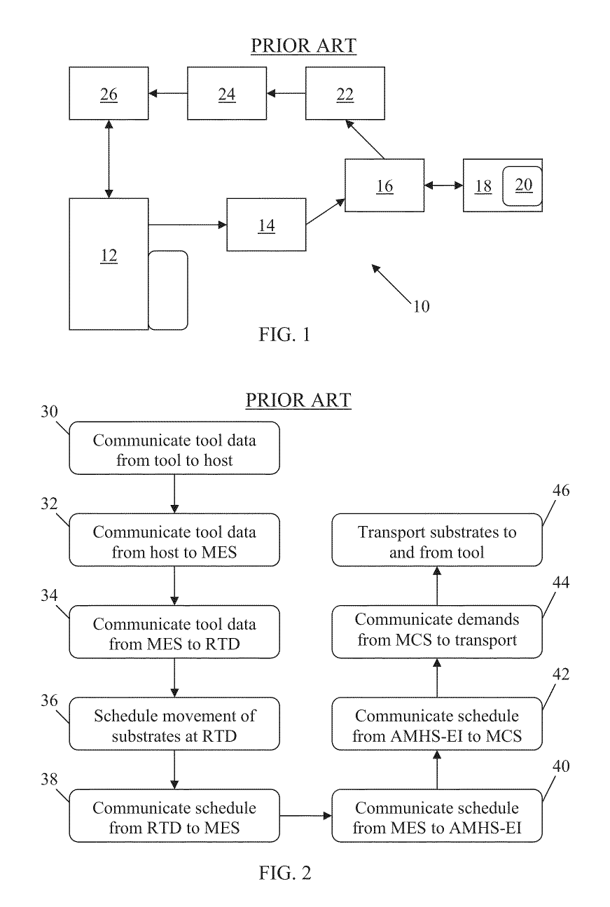

In a conventional semiconductor fabrication system 10 as shown in FIG. 1, a tool 12 communicates data to an equipment interface (EI) or host controller (host) 14. The host 14 is shown to communicate information to a Manufacturing Execution System (MES) 16. Further, the MES 16 transmits and receives data from a Real Time Dispatch (RTD) 18. As shown, the RTD 18 includes a scheduler 20 for scheduling movement of substrates within system 10. Typically, substrates are contained in lots that are carried by substrate carriers, and are identified and tracked through the system 10.

In FIG. 1, the MES 16 also communicates to an Automated Material Handling System Equipment Interface (AMHS-EI) 22. As shown, the AMHS-EI 22 transmits data to an AMHS Material Control System (MCS) 24. Further, the MCS 24 transmits commands to a transport system 26 such as an overhead transport system. The transport system 26 can deliver substrate carriers holding substrates to the tool 12 for processing and remove processed substrates from the tool 12.

In FIG. 2, the method employed by the prior art fabrication system 10 to transport substrates to and from the tool 12 for processing is represented. As shown at step 30, the tool 12 communicates to the host 14 tool data consisting of the identity of the lots of substrates at the tool 12, and the number of steps remaining before processing of the substrates is completed. The host 14 communicates the tool data to the MES 16 at step 32, and the MES 16 passes it on to the RTD 18 at step 34.

The scheduler 20 within the RTD 18 then schedules the movement of the processed substrates away from the tool 12 (after the completion of processing therein) and the movement of new substrates to the tool 12 at step 36. It is important to note that the scheduler 20 within the RTD is responsible to scheduling movement of substrates to and from a large plurality of tools 12, possibly all of the tools in the fabrication facility. As a result, the scheduler 20 in the RTD 18 may not immediately schedule movement of substrates to and from a particular tool 12.

After the scheduler creates the scheduling data, the data is sent back from the RTD 18 to the MES 16 at step 38. The MES 16 delivers the schedule data to the AMHS-EI 22 at step 40. As shown, the AMHS-EI 22 communicates the schedule data to the MCS 24 at step 42. The MCS 24 then issues movement commands to the transport system 26 at step 44. Upon receipt of the movement commands, the transport system 26 removes the processed substrates from the tool 12 and delivers unprocessed substrates to the tool 12 for processing at step 46. As used herein, “unprocessed substrates” refer to those substrates that await a process step at the relevant tool, including those substrates that have been processed by other tools and those that have been processed by the relevant tool at an earlier stage of fabrication.

In addition to delays caused by the computational load on the scheduler 20 in the RTD 18 when acting as the sole scheduler for all tools 12 in a fabrication facility, the latency of the communication loop in the system 10, from tool 12 up to RTD 18 and back to transport system 26, typically causes the steps of FIG. 2 to take more than 30 seconds, and often minutes, to be performed. Further, the tool data utilized by the scheduler 20 is not comprehensive as it contains only the identity of substrate lots at the tool 12 and the number of steps remaining in the processing at tool 12. Certain detailed tool data, including for example, tool temperature data or a predicted process completion time, is not communicated to the RTD 18 or scheduler 20. As a result, a tool 12 may complete processing of substrates and be left idle for several minutes before the transport system 26 is commanded to remove the processed substrates and deliver new substrates for processing.

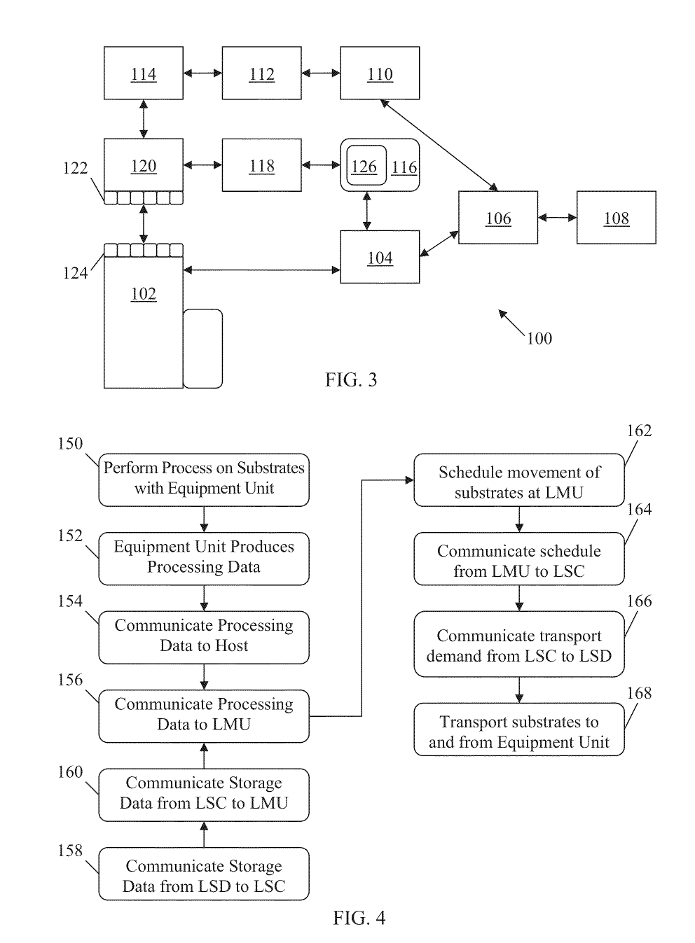

In order to reduce or eliminate idle time of tools, the semiconductor fabrication system 100 in FIG. 3 incorporates local processing management. As shown, the system 100 includes an equipment unit 102, which may be a process module or process tool for performing a fabrication process, a metrology process, a sorting process or a handling process. “Equipment unit” is used herein to refer to any process equipment, such as process modules and process tools, whether for fabricating, measuring, sorting, or handling. As used herein, a process may refer to a fabrication, metrology, sorting or handling process. As further shown, equipment unit 102 is in communication with an equipment interface (EI) or host controller (host) 104.

The host 104 is in communication with a Manufacturing Execution System (MES) 106. Further, the MES 106 transmits and receives data from a Real Time Dispatch (RTD) 108. The MES 106 is also shown to be in communication with an Automated Material Handling System Equipment Interface (AMHS-EI) 110. The AMHS-EI 110 communicates with an AMHS Material Control System (MCS) 112. Further, the MCS 112 communicates with a transport system 114 such as an overhead transport system.

As shown in FIG. 3, the system 100 also includes a local management unit 116. Specifically, the local management unit 116 communicates directly with the host 104 to receive equipment data. Further, the local management unit 116 is in communication with a local storage control 118, or buffer control unit. The local storage control 118 communicates with a local storage device 120, which may be a fixed buffer or internal buffer. As shown, the local storage device 120 includes a plurality of input/output ports 122 or buffer ports for receiving substrate carriers. Further, the input/output ports 122 are arranged for interaction with equipment ports 124 on the equipment unit 102. As a result, substrate carriers or substrates may be exchanged between the equipment unit 102 and local storage device 120.

In system 100, a scheduler 126 is positioned at the local management unit 116. Further, the local management unit 116 receives processing data which may include a predicted process completion time, the identity of substrate lots at the equipment unit 102, the number of steps remaining in a process at the equipment unit 102, the status of equipment ports 124 (whether vacant or occupied) at the equipment unit 102, the status of input/output ports 122 (vacant or occupied) at the local storage device 120, the identify of substrate lots at the local storage device 120, substrate temperature data, equipment temperature data, storage device temperature data, sensor information, process parameters, preventative maintenance data, carrier state information, substrate location and/or process data, and/or robot interlock information among other equipment and storage device information.

In FIG. 4, the method employed by the system 100 to transport substrates to and from the equipment unit 102 for processing during semiconductor fabrication is illustrated. At step 150, the equipment unit performs a process on substrates, such as a fabrication process like photolithography, etching, cleaning, doping, dicing or other typical semiconductor fabrication process, a metrology process, a sorting process, or a handling process. At step 152, the equipment unit 102 produces equipment data, such as the identity of substrate lots at the equipment unit 102, the number of steps remaining in the current process at the equipment unit 102, the status of equipment ports 124 (whether vacant or occupied) at the equipment unit 102, a predicted process completion time for the substrate lot currently undergoing processing, substrate temperature data, equipment temperature data, sensor information, sensor status, process parameters, preventative maintenance data, carrier state information, substrate location and/or process data, robot interlock information, status of internal automation components, and/or digital inputs among other equipment information. Such equipment data may vary depending on the manufacturer of the equipment unit 102.

At step 154, the equipment unit communicates the equipment data to host 104. The host 104 communicates the equipment data to the local management unit (LMU) 116 at step 156. Concurrently, at step 158 the local storage device (LSD) 120 communicates to the local storage control (LSC) 118 storage data including the status of input/output ports 122 (vacant or occupied) at the local storage device 120, the identify of substrate lots at the local storage device 120, storage device temperature data, substrate temperature data, sensor information, preventative maintenance data, carrier state information, and robot interlock information among other storage information. Such storage data may vary depending on the manufacturer of the local storage device 120. At step 160, the local storage control 118 communicates the storage data to the local management unit 116.

Armed with detailed equipment data and storage data not conventionally available to scheduler 20 of FIG. 1, the scheduler 126 at the local management unit 116 of FIGS. 3-4 schedules movement of substrate lots between the equipment unit 102 and the local storage device 120 at step 162. The schedule is communicated to the local storage control 118 at step 164. The local storage control 118 then issues at step 166 a transport command to the local storage device 120 for the removal of a processed lot of substrates from the equipment unit 102 and for the delivery of an unprocessed lot of substrates to the equipment unit 102. In response to the command, the local storage device 120 removes the processed lot from the equipment unit 102 and delivers an unprocessed lot to the equipment unit 102 at step 168.

As a result of the amount and type of information specific to equipment unit 102 and local storage device 120 provided to the scheduler 126, the reduced number of steps and exchanges in communicating that information, and the reduced burden on the scheduler 126 (as compared to a facility-wide scheduler 20), the system 100 of FIG. 3 is able to remove processed substrates from the equipment unit 102 in less than 20 seconds, less than 10 seconds, less than 5 seconds, less than 3 seconds, or less than 1 second, and most preferably in the order of milliseconds of the completion of their processing. Further, the system 100 of FIG. 3 is able to deliver new substrates from the local storage device 120 to the equipment unit 102 in less than 20 seconds, less than 10 seconds, less than 5 seconds, less than 3 seconds, or less than 1 second, and most preferably in the order of milliseconds, of the completion of processing on a preceding lot of substrates.

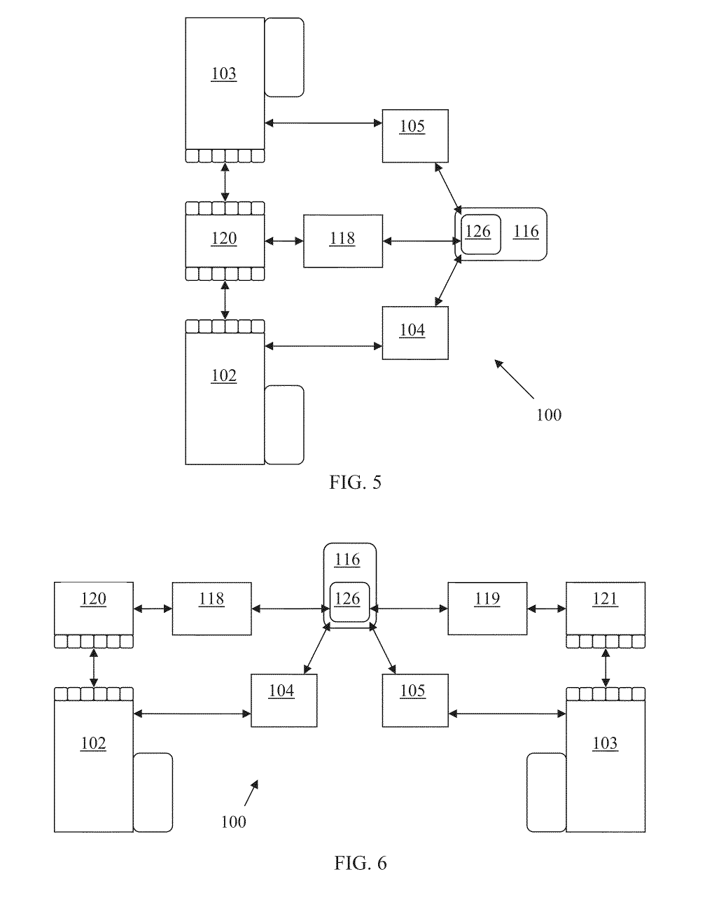

It is noted that a single equipment unit 102 associated with a single local storage device 120 is illustrated in FIG. 3. However, it is contemplated that the local management unit 116 may be utilized in a variety of embodiments. For instance, in FIG. 5, two equipment units 102 and 103 are serviced by a single local storage device 120. As shown, each equipment unit 102 and 103 is in communication with a respective host 104 and 105. Further, each host 104 and 105 is in communication with the local management unit 116. Also, the local storage device 120 and local storage control 118 are in communication with the local management unit 116. In the embodiment shown in FIG. 5, the scheduler 126 in the local management unit 116 is able to schedule the transport of substrates between the local storage device 120 and both equipment units 102 and 103. It is noted that the equipment units 102 and 103 may represent a plurality of related or associated equipment units which interact with hosts 104 and 105 respectively.

FIG. 6 depicts another embodiment, in which a local management unit is used to control substrate movement at two equipment units. As shown, each equipment unit 102 and 103 is associated with and serviced by a dedicated local storage device 120 and 121, respectively. Further, each equipment unit 102 and 103 communicates with its own host 104 and 105, respectively. As shown, each host 104 and 105 is in communication with the local management unit 116. Likewise, each local storage device 120 and 121 communicates with a local storage control 118 and 119 that is in communication with the local management unit 116. The scheduler 126 in the local management unit 116 is able to schedule the transport of substrates between the local storage devices 120 and 121 and the respective equipment unit 102 and 103. It is again noted that the equipment units 102 and 103 may represent a plurality of related or associated equipment units which interact with hosts 104 and 105 and local storage devices 120 and 121, respectively.

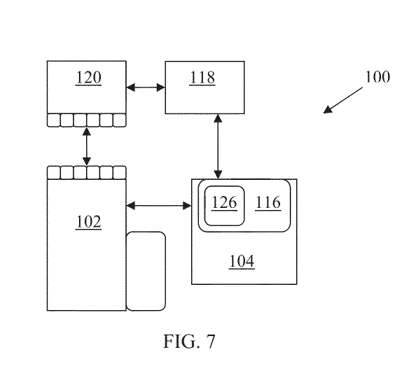

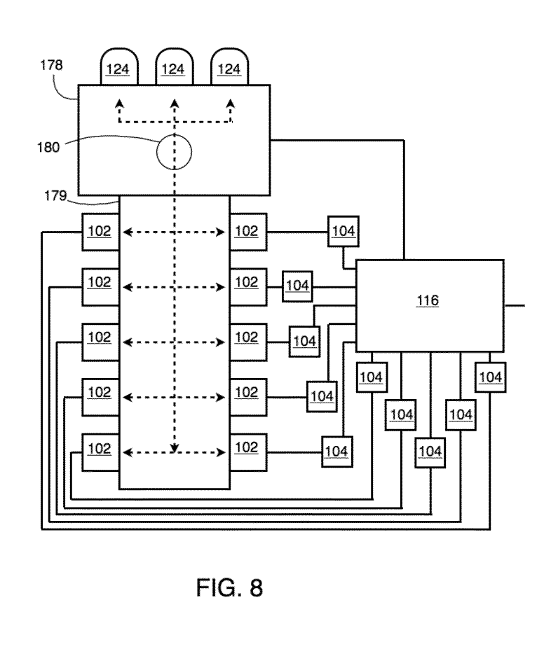

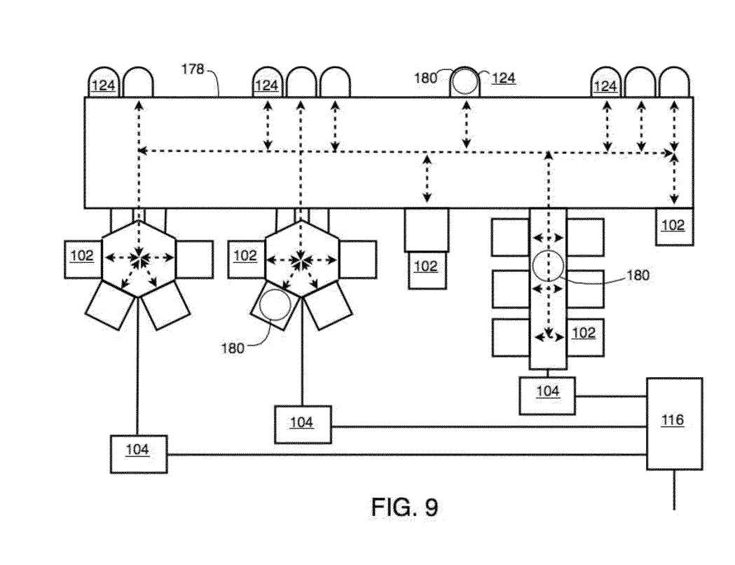

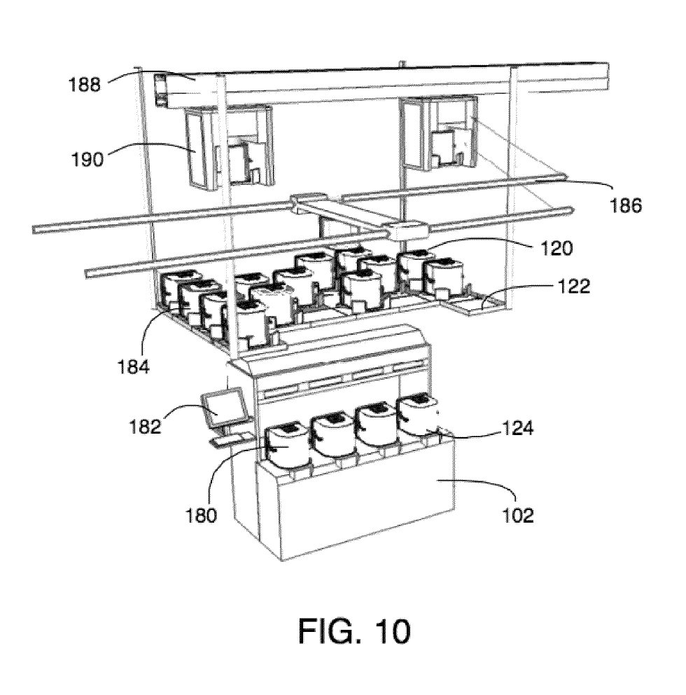

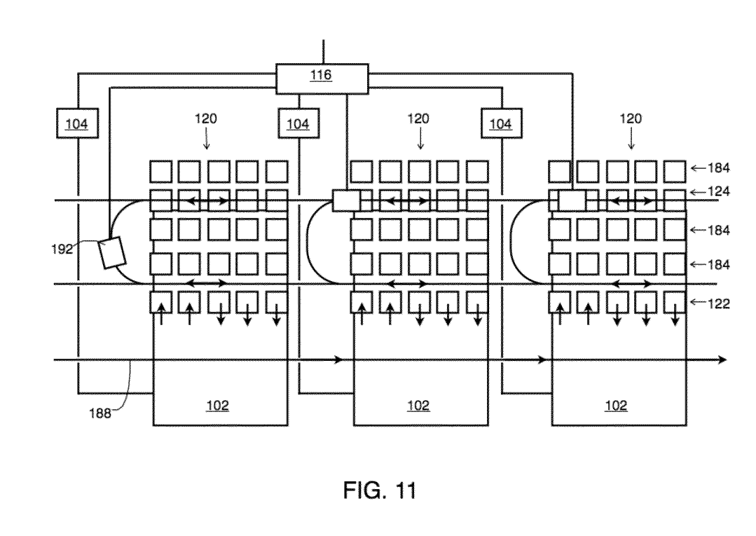

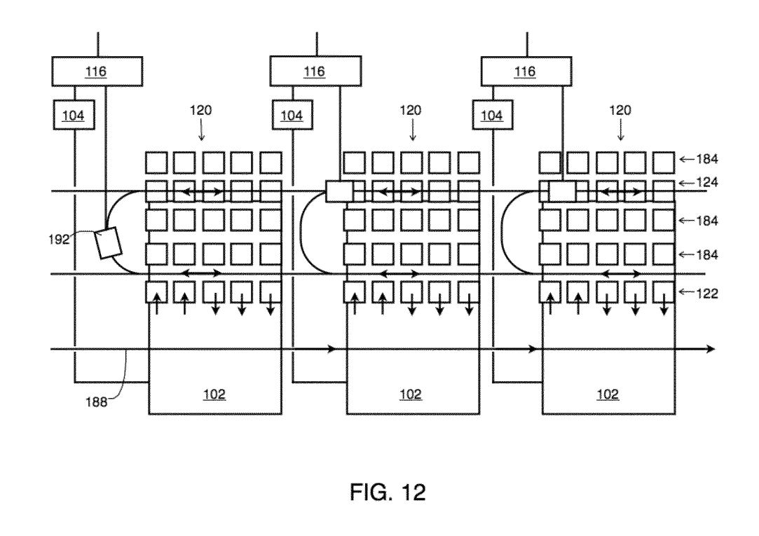

Referring to FIG. 7, an alternate embodiment is illustrated. Again, the equipment unit 102 is in communication with host 104. However, in FIG. 7, the local management unit 116 is positioned in, or part of, host 104. As a result, the scheduler 126 is within host 104. As shown, the host 104, local management unit 116 and scheduler 126 are in communication with the local storage control 118. Further, the local storage control is in communication with the local storage device 120 which is able to transport substrates to and from the equipment unit 102.

Referring now to FIG. 8, another arrangement of the system 100 is shown. In FIG. 8, a plurality of equipment units 102 in the form of process modules, are arranged and assembled in an Equipment Front End Module (EFEM) 178. As shown, the EFEM 178 is connected to an internal wafer handling mechanism 179. Further, the EFEM 178 is provided with equipment ports 124 that are linked to the equipment units 102, as shown by the dashed lines and arrows. During processing, substrates 180 may be loaded at one of the equipment ports 124 and delivered to an equipment unit 102 through the internal wafer handling mechanism 179. Further, each equipment unit 102 is interconnected with the local management unit 116 through a host 104.

FIG. 9 depicts another EFEM arrangement. As shown, the EFEM 178 includes a variety of arrangements of equipment units 102. Further, the EFEM 178 is provided with differing arrangements of equipment ports 124. In arranging the EFEM 178, equipment ports 124 may be identified for dedicated service to a specific equipment unit 102. However, in operation, any equipment port 124 may be used to deliver or remove substrates 180 from a particular equipment unit 102. In FIG. 9, hosts 104 are shown to be associated with pluralities of equipment units 102, rather than with single equipment units 102, though either arrangement may be used in system 100. Again, dashed lines illustrate the possible movement of substrates 180 between equipment ports 124 and equipment units 102 through the EFEM 178.

Referring to FIG. 10, an equipment unit 102, such as a process tool, is shown in relation to a dedicated local storage device 120, or buffer. As shown, the equipment tool 102 includes four equipment ports 124. Also, the equipment unit 102 includes a data input 182. The local storage device 120 includes two input/output ports 122 and fifteen storage positions 184 for holding substrates 180 (as shown, substrates 180 are held in twelve storage positions 184 and on one input/output port 122). The local storage device 120 is also provided with a transport mechanism 186 for moving substrates between the input/output ports 122 and equipment ports 124. As is further shown, an overhead transportation system 188 is provided to deliver substrates to and from the local storage device 120 from other locations in the fabrication facility. The overhead transportation system 188 includes a hoist 190 that may transport substrates 130 to and from the input/output ports 122 of the local storage device 120, or directly to and from the equipment ports 124 of the equipment unit 102.

FIGS. 11 and 12 provide an overhead view of two embodiments of system 100. As shown, each equipment unit 102 is positioned with its five equipment ports 124 adjacent a local storage device 120 that includes fifteen storage positions 184 and five input/output ports 122. As shown, each equipment unit 102 is in communication with its host 104, which is in direct communication with the local management unit 116. Further, the local management unit 116 is in communication with a storage transport vehicle 192. As shown, the vehicles 192 move along a track 194 in order to move substrates between ports 122 and 124. With the illustrated connections, the local management unit 116 is able to efficiently manage the movement of substrates between the ports 122 and 124 by vehicles 192. FIG. 12 includes a similar arrangement, but provides for management of the three equipment units 102 and vehicles 192 by three distinct local management units 116.

It is noted that the system 100 may be used both to manage movement of substrate carriers to and from process equipment units and/or to manage movement of wafer substrates to and from process modules, concurrently. As a result, movement of substrate carriers and substrates is managed at the millisecond level.

In view of the various illustrated embodiments, a fabrication facility may incorporate different embodiments for local processing management across different fabrication sectors or for different types of equipment units and hosts. Also, the information provided to the local management units 116 allows for specialized treatment of substrate lots and carriers by the local storage device and equipment units. For instance, a substrate lot is typically delivered to and removed from equipment units in associated substrate carriers. In the present method and system, the local management unit may provide a schedule which requires the disassociation of substrates from a substrate carrier. As a result, a substrate carrier can be removed from an equipment port while its formerly associated substrates remain in the equipment unit. This ability is particularly appealing when substrate carriers hold varying numbers of substrates, and allows for increase throughput at the equipment unit, as an equipment port is available to receive another substrate carrier. The local management unit 116 may then assign the disassociated substrates to a new substrate carrier, join the disassociated substrates to another substrate lot, or re-associate the substrates with their former carrier.

Accordingly, a semiconductor fabrication method and system with local and distributed processing management has been provided. From the foregoing, it is to be appreciated that the exemplary embodiments of the semiconductor fabrication method and system provide for reduced idle time of equipment units between completion of a process on substrates and commencement of processing a successive lot of substrates. Further, the semiconductor fabrication method and system schedule removal of processed substrates and delivery of new substrates to the equipment unit synchronized with the completion of processing on the preceding substrate or lot of substrates.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the semiconductor fabrication methods and systems in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the appended claims and their legal equivalents.

What is claimed is:

1. A method of semiconductor fabrication comprising:
performing a process on substrates with an equipment unit to form processed substrates;
communicating processing data from the equipment unit to a local scheduler; and
scheduling removal of processed substrates from the equipment unit and delivery of unprocessed substrates to the equipment unit by the local scheduler based on the processing data.

2. The method of claim 1 wherein the equipment unit is selected from the group consisting of a fabrication process tool, a metrology process tool, a sorting process tool, a substrate handling process tool, a fabrication process module, a metrology process module, a sorting process module, and a substrate handling process module.

3. The method of claim 1 wherein the processing data is communicated directly from the equipment unit to a host, and directly from the host to the local scheduler.

4. The method of claim 1 wherein the processing data includes data selected from the group consisting of a predicted process completion time, sensor information, temperature data, process parameters, preventative maintenance data, carrier state information, substrate location, and robot interlock data.

5. The method of claim 1 wherein unprocessed substrates are delivered to the equipment unit from a local storage device, wherein processed substrates are removed from the equipment unit to the local storage device, and wherein a local storage controller directs delivery of unprocessed substrates and removal of the processed substrates.

6. The method of claim 5 wherein the local storage device delivers unprocessed substrates to, and removes processed substrates from, a plurality of equipment units.

7. The method of claim 1 wherein the equipment unit includes equipment ports for receiving substrates, wherein each equipment port has a vacant or occupied status, wherein the method further comprises communicating the status of each equipment port from the equipment unit to the local scheduler, and wherein the local scheduler schedules removal of processed substrates from the equipment unit and delivery of substrates to the equipment unit based on the status of each equipment port.

8. The method of claim 7 wherein unprocessed substrates are delivered to and processed substrates are removed from a local storage device under direction of a local storage controller, wherein the local storage device includes storage ports for receiving substrates, wherein each storage port has a vacant or occupied status, wherein the method further comprises communicating the status of each storage port from the local storage controller to the local scheduler, and wherein the local scheduler schedules removal of processed substrates from the equipment unit and delivery of substrates to the equipment unit based on the status of each storage port.

9. The method of claim 1 wherein the substrates are delivered and removed in substrate carriers, and wherein the substrate carriers hold varying numbers of substrates.

10. The method of claim 1 wherein the substrates are delivered and removed in associated substrate carriers, the method further comprising communicating a command from the local scheduler to the tool to disassociate selected substrates from the respective associated substrate carrier and to remove the disassociated substrate carrier from the tool.

11. A method of semiconductor fabrication employing local processing management comprising:
providing a plurality of equipment units;
associating each equipment unit to a respective local scheduler;
performing a process on substrates with each equipment unit to form processed substrates;
communicating processing data from each equipment unit to its associated local scheduler; and
scheduling removal of processed substrates from each equipment unit to an associated local storage device and delivery of unprocessed substrates from the respective associated local storage device to each equipment unit by the respective local scheduler based on the respective processing data.

12. The method of claim 11 wherein each equipment unit is selected from the group consisting of a fabrication process tool, a metrology process tool, a sorting process tool, a substrate handling process tool, a fabrication process module, a metrology process module, sorting process module, and a substrate handling process module.

13. The method of claim 11 wherein the processing data is communicated directly from each equipment unit to a respective host, and directly from the respective host to the associated local scheduler.

14. The method of claim 11 wherein a respective local storage controller directs delivery of unprocessed substrates and removal of processed substrates for equipment units associated with the respective local storage device.

15. The method of claim 11 wherein each equipment unit includes equipment ports for receiving substrates, wherein each equipment port has a vacant or occupied status, wherein the method further comprises communicating the status of each equipment port from each equipment unit to the respective associated local scheduler, and wherein each associated local scheduler schedules removal of processed substrates from each equipment unit and delivery of unprocessed substrates to each equipment unit based on the status of each equipment port.

16. The method of claim 15 wherein each local storage device includes storage ports for receiving substrates, wherein each storage port has a vacant or occupied status, wherein each local storage controller directs delivery of unprocessed substrates and removal of processed substrates, wherein the method further comprises communicating the status of each storage port from each local storage controller to the respective associated local scheduler, and wherein each associated local scheduler schedules removal of processed substrates from each respective equipment unit and delivery of unprocessed substrates to each respective equipment unit based on the status of each storage port.

17. The method of claim 11 wherein the processing data includes data selected from the group consisting of a predicted process completion time, sensor information, temperature data, process parameters, preventative maintenance data, carrier state information, substrate location, and robot interlock data.

18. The method of claim 11 wherein each local scheduler is associated with a plurality of the equipment units.

19. The method of claim 18 wherein the plurality of equipments units associated with a respective local scheduler includes at least two equipment units selected from the group consisting of a fabrication process tool, a metrology process tool, a sorting process tool, a substrate handling process tool, a fabrication process module, a metrology process module, sorting process module, and a substrate handling process module.

20. A semiconductor fabrication system comprising:
an equipment unit configured to perform a process on substrates to form processed substrates and configured to produce processing data;
a local storage device configured to hold substrates and to transport substrates to and from the equipment unit; and
a local scheduler in communication with the equipment unit and the local storage device and configured to schedule removal of processed substrates from the equipment unit and delivery of unprocessed substrates to the equipment unit based on the processing data.
